(19) United States
(12) Patent Application Publication
(10) Pub. No.: US 2026/0284654 A1
(43) Pub. Date: Sep. 24, 2026

(54) BIOSENSING DEVICE AND OPTICAL SYSTEM USING THE SAME

(71) Applicant: VisEra Technologies Company Limited, Hsin-Chu City (TW)

(72) Inventors: Hsin-Yi HSIEH, Hsin-Chu City (TW); Yi-Hsin TAI, Hsin-Chu City (TW); Chung-Jung HSU, Hsin-Chu City (TW)

(21) Appl. No.: 19/339,708

(22) Filed: Sep. 25, 2025

Related U.S. Application Data
(60) Provisional application No. 63/773,546, filed on Mar. 18, 2025.

(51) Int. Cl. B01L 3/00

(52) U.S. Cl. CPC B01L 3/502715; B01L 2300/0654; B01L 2300/0816; B01L 2300/168

(57) ABSTRACT

A biosensing device is provided. The biosensing device includes a substrate. A top microlens and a bottom microlens are disposed on the two sides of the substrate. The biosensing device also includes a first upper cladding layer disposed above the substrate. The first upper cladding layer has at least one reaction site. The biosensing device further includes a collimating element disposed between the reaction site and the top microlens.

### CROSS REFERENCE TO RELATED APPLICATIONS

This application claims the benefit of U.S. Provisional Application No. 63/773,546 filed on Mar. 18, 2025, the entirety of which is incorporated by reference herein.

### TECHNICAL FIELD

The present disclosure relates to a biosensing device and an optical system using the same, and more particularly to a disposable biosensing device that includes a collimating element for high-throughput fluorescence detection and an optical system using the same.

### BACKGROUND

Current fluorescence-based biosensing systems face a fundamental trade-off between light collection efficiency (EFF) and field-of-view (FoV). Systems employing high-numerical-aperture (NA) objective lenses often achieve EFF exceeding 10% but are limited to a FoV of merely 200 to 300 μm in diameter. Conversely, systems with a large FoV (e.g., greater than 2 mm) typically suffer from poor EFF (e.g., less than 1%), compromising detection sensitivity and resolution, which is critical in single-molecule or low-concentration applications like DNA sequencing.

Some existing cases observe the object to be tested (e.g., bio samples) through a 20× or 40× objective lens, which yield limited FoV (e.g., about 1 mm). Others attempt to integrate the sample carrier directly onto the CMOS sensor, which significantly increases chip cost. Furthermore, confocal microscopy approaches offer better scalability but suffer from Z-axis confinement widths of about 300 nm, which is substantially larger than the 50 nm confinement offered by waveguide excitation, leading to higher background noise and reduced signal-to-noise ratio. Therefore, existing cases are not satisfactory in all aspects.

### BRIEF SUMMARY

The present disclosure provides a novel biosensing device that includes a specially designed collimating element. Fluorescent signals originating from bio samples within reaction sites are collimated via the collimating element. These collimated beams then pass through a sufficiently thick substrate, maintaining their spatial orientation and intensity.

The biosensing device and the optical system according to the embodiments of the present disclosure may achieve a high collection efficiency, a large FoV through spatially aligned optical relays, cost-effectiveness via reusable image sensor (e.g., CMOS) and disposable optical front ends, and an accurate intensity quantification over single-molecule signal arrays.

An embodiment of the present disclosure provides a biosensing device. The biosensing device includes a substrate. A top microlens and a bottom microlens are disposed on the two sides of the substrate. The biosensing device also includes a first upper cladding layer disposed above the substrate. The first upper cladding layer has at least one reaction site. The biosensing device further includes a collimating element disposed between the reaction site and the top microlens.

In some embodiments, the biosensing device includes a second upper cladding layer and a waveguide layer. The second upper cladding layer is disposed between the substrate and the first upper cladding layer. The waveguide layer is disposed between the first upper cladding layer and the second upper cladding layer.

In some embodiments, the waveguide layer has at least one grating coupler.

In some embodiments, the waveguide layer includes tantalum pentoxide, silicon nitride, niobium oxide, or aluminum oxide.

In some embodiments, the reaction site is a well structure, the height of the well structure is in a range from 50 nm to 3 μm, the maximum width of the well structure is in a range from 30 nm to 5 μm, and the distance between the bottom of the well structure and the waveguide layer is in a range from 1 nm to 200 nm.

In some embodiments, the collimating element is embedded in the second upper cladding layer and aligned with the well structure.

In some embodiments, the top microlens is embedded in the second upper cladding layer, and the refractive index of the top microlens is greater than the refractive index of the second upper cladding layer.

In some embodiments, the collimating element includes a metalens, a Fresnel lens, or a microlens.

In some embodiments, the thickness of the substrate is in a range from 50 μm to 1000 μm.

In some embodiments, the minimum distance between a focus plane of the top microlens and the top microlens is less than or equal to half the thickness of the substrate.

In some embodiments, the refractive index of the substrate is in a range from 1.4 to 2.2.

In some embodiments, the focal length of the bottom microlens is equal to the focal length of the top microlens.

In some embodiments, the refractive index of the bottom microlens is greater than or equal to the refractive index of the top microlens.

In some embodiments, the biosensing device further includes a lower cladding layer disposed under the substrate. The bottom microlens is embedded in the lower cladding layer.

In some embodiments, the biosensing device further includes an upper planarization layer and a lower planarization layer. The upper planarization layer is disposed between the substrate and the collimating element, and the top microlens is embedded in the upper planarization layer. The lower planarization layer is disposed under the substrate, and the bottom microlens is embedded in the lower planarization layer.

In some embodiments, light beams remain collimated after passing through the bottom microlens.

In some embodiments, the focal length of the light beams after passing through the bottom microlens is in a range from 10 μm to 5 mm.

An embodiment of the present disclosure provides an optical system. The optical system includes a biosensing device. The biosensing device includes a substrate. A top microlens and a bottom microlens are disposed on the two sides of the substrate. The biosensing device also includes a first upper cladding layer disposed above the substrate. The first upper cladding layer has at least one reaction site. The biosensing device further includes a collimating element disposed between the reaction site and the top microlens. The optical system includes also includes an image sensor for sensing light beams from the biosensing device. The optical system includes further includes an intermediate optical device between the biosensing device and the image sensor.

In some embodiments, the intermediate optical device includes an object-space lens having a first focal length and an image-space lens having a second focal length. The image-space lens is closer to the image sensor than the object-space lens. The first focal length is greater than or equal to the second focal length. The second focal length is greater than or equal to 0.1 times the first focal length.

In some embodiments, the object-space lens is a telecentric lens or both the object-space lens and the image-space lens are telecentric lenses.

In some embodiments, the optical system further includes a light-shielding element disposed on the conjugate plane of the object-space lens and the image-space lens. The light-shielding element has an aperture, and the center of the aperture is on an optical axis of the light beams.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a partial cross-sectional view illustrating the biosensing device according to some embodiments of the present disclosure.

FIG. 2 is a partially enlarged cross-sectional view illustrating the region E1 in FIG. 1 according to some embodiments of the present disclosure.

FIG. 3 is a partially enlarged cross-sectional view illustrating the region E2 in FIG. 1 according to some embodiments of the present disclosure.

FIG. 4, FIG. 5, FIG. 6, and FIG. 7 are partially enlarged cross-sectional views illustrating the region E2 in FIG. 1 according to some other embodiments of the present disclosure.

FIG. 8 is a partial cross-sectional view illustrating the optical system according to some embodiments of the present disclosure.

FIG. 9 is a partial cross-sectional view illustrating the optical system according to some other embodiments of the present disclosure.

### DETAILED DESCRIPTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in the following embodiments. This repetition is for the purpose of simplicity and clarity and does not in itself dictate a relationship between the various embodiments and/or configurations discussed.

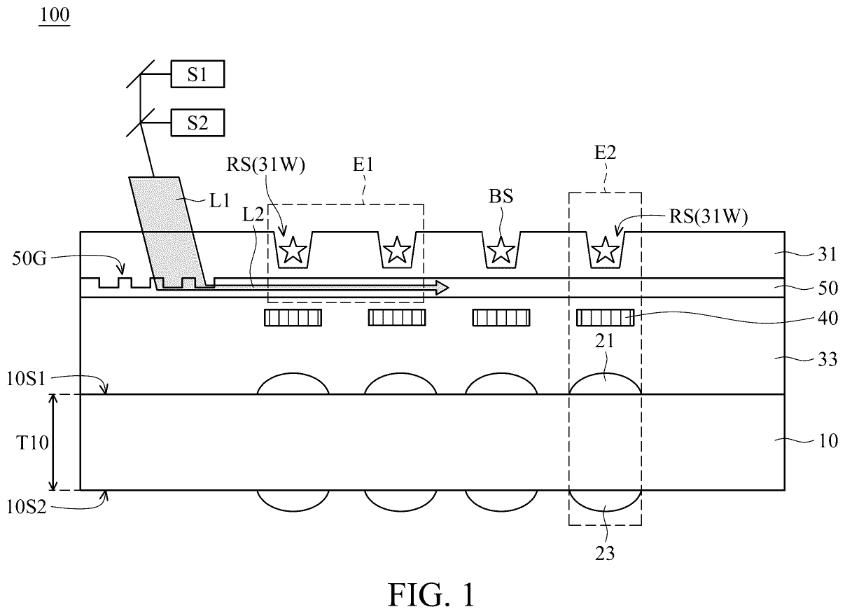

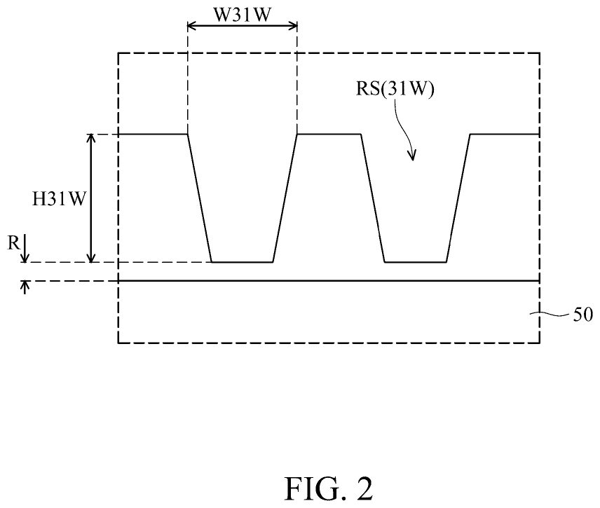

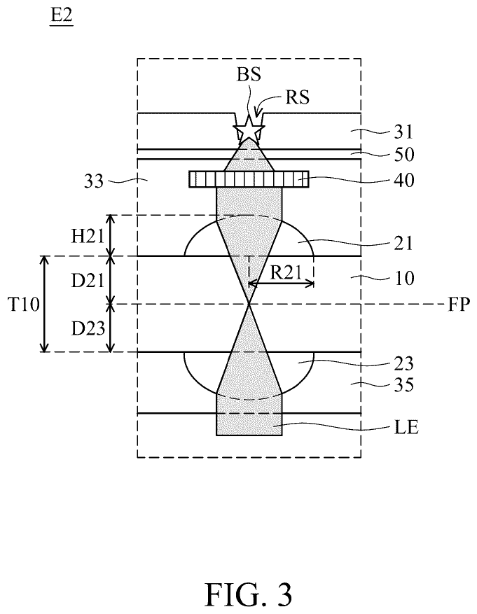

FIG. 1 is a partial cross-sectional view illustrating the biosensing device 100 according to some embodiments of the present disclosure. FIG. 2 is a partially enlarged cross-sectional view illustrating the region E1 in FIG. 1 according to some embodiments of the present disclosure. FIG. 3 is a partially enlarged cross-sectional view illustrating the region E2 in FIG. 1 according to some embodiments of the present disclosure. It should be noted that some components of the biosensing device 100 have been omitted in FIG. 1 to FIG. 3 for the sake of brevity.

Referring to FIG. 1 and FIG. 3, in some embodiments, the biosensing device 100 includes a substrate 10. For example, the substrate 10 is a glass substrate, which may include a flexible material, such as polyethylene terephthalate (PET), polysulfone (PES), polyimide (PI), polycarbonate (PC), polymethylmethacrylate (PMMA), silicone, epoxy, the like, or a combination thereof. Alternately, the substrate 10 may also include a rigid material, such as a glass, a quartz, or a sapphire.

The substrate 10 may be transparent or semi-transparent. More specifically, in the examples where the substrate 10 is transparent, the material of the substrate 10 may have a light transmittance to light with a wavelength in a range from 400 nm to 750 nm greater than about 85%, or greater than about 92%. In the examples where the substrate 10 is semi-transparent, the material of the substrate 10 may have a light transmittance to light with a wavelength in a range from 400 nm to 750 nm greater than about 25% and less than about 85%, but the present disclosure is not limited thereto. In some embodiments, the refractive index of the substrate 10 is in a range from about 1.4 to about 2.2. As shown in FIG. 1 and FIG. 3, in some embodiments, the thickness T10 of the substrate 10 is in a range from about 50 μm to about 1000 μm.

Referring to FIG. 1 and FIG. 3, in some embodiments, the biosensing device 100 includes a top microlens 21 and a bottom microlens 23 that are disposed on the two sides of the substrate 10. In more detail, as shown in FIG. 1, the top microlens 21 is disposed on one side 10S1 of the substrate 10, and the bottom microlens 23 is disposed on the other side 10S2 that is the opposite side of the side 10S1. For example, the top microlens 21 and the bottom microlens 23 may include glass, epoxy resin, silicone resin, polyurethane, any other applicable material, or a combination thereof, but the present disclosure is not limited thereto. The top microlens 21 and the bottom microlens 23 may be formed by a photoresist reflow method, a hot embossing method, any other applicable method, or a combination thereof. Moreover, the steps of forming the top microlens 21 and the bottom microlens 23 may include a spin coating process, a lithography process, an etching process, any other applicable process, or a combination thereof.

In this embodiment, each of the top microlens 21 and the bottom microlens 23 is semi-convex lens, but the present disclosure is not limited thereto. For example, in the top view (e.g., FIG. 3), the radius R21 of the top microlens 21 may be in a range from about 0.3 μm to about 300 μm (or about 1 μm to 50 μm), and the thickness H21 of the top microlens 21 may be in a range from about 0.3 μm to about 50 μm (or about 0.5 μm to 20 μm), but the present disclosure is not limited thereto.

The top microlens 21 or the bottom microlens 23 may also be a convex lens or a portion of the convex lens. In other cases, the top microlens 21 and the bottom microlens 23 may be micro-pyramid structures (e.g., circular cone or quadrangular pyramid), micro-trapezoidal structures (e.g., flat top cone or truncated Square Pyramid), or gradient-index structures, which may be adjusted according to actual needs. In some embodiments, the focal length of the bottom microlens 23 is equal to the focal length of the top microlens 21.

Referring to FIG. 1 and FIG. 3, in some embodiments, the biosensing device 100 includes an upper cladding layer 31 disposed above the substrate 10, and the upper cladding layer 31 has reaction sites RS for bio samples BS immobilization. For example, the upper cladding layer 31 may include a transparent dielectric material that has a low refractive index in a range from about 1.0 to about 1.99, such as silicon dioxide (SiO₂), but the present disclosure is not limited thereto. The upper cladding layer 31 may be formed by a deposition process. The deposition process is, for example, chemical vapor deposition (CVD), plasma enhanced chemical vapor deposition (PECVD), atomic layer deposition (ALD), any other similar process, or a combination thereof, but the present disclosure is not limited thereto.

As shown in FIG. 1 and FIG. 3, in this embodiment, each reaction site RS is a well structure 31W, such as a nano-well or a vial. That is, the upper cladding layer 31 may have an opening as the well structure 31W. A selective surface coating may be performed to modify the bottom surface of the well structures 31W with a functional group that may be able to capture bio samples BS. Thus, the bio samples BS may be localized in the reaction site RS. In other embodiments, the upper cladding layer 31 may not have an opening as the reaction sites RS. The reaction site RS may be formed by modifying a portion of the surface of the upper cladding layer 31 so that only a certain region may capture desired bio samples BS.

The well structure 31W may be formed by a patterning process. The patterning process may include, for example, forming a mask layer (not illustrated) on the upper cladding layer 31, then etching the portion of the upper cladding layer 31 that is not covered by the mask layer, but the present disclosure is not limited thereto. The mask layer may include a photoresist, such as a positive photoresist or a negative photoresist. For example, the mask layer may include a metal, a metal oxide, a metal nitride (e.g., Ti, TiO₂, TiN, Al, Al₂O₃, AlN, Cr, or Nb,) or a dielectric material (e.g., silicon oxide (SiO₂), silicon nitride (SiN), silicon oxynitride (SiON), silicon carbide (SiC), silicon carbonitride (SiCN)), or a combination thereof. The mask layer may be a single layer or a multilayer structure.

As shown in FIG. 2, in some embodiments, the height H31W of the well structure 31W is in a range from about 50 nm to 3 μm, and the maximum width W31W of the well structure 31W is in a range from about 30 nm to about 5 μm.

Referring to FIG. 1 and FIG. 3, in some embodiments, the biosensing device 100 includes a collimating element 40 disposed between the reaction site RS and the top microlens 21. In more detail, in this embodiment, the collimating element 40 is disposed between the well structure 31W and the top microlens 21. In some embodiments, the collimating element 40 includes a metalens, a Fresnel lens, or a microlens, but the present disclosure is not limited thereto. For example, the collimating element 40 may include tantalum pentoxide (Ta₂O₅), silicon nitride (Si₃N₄), niobium(V) oxide (Nb₂O₅), aluminum oxide (Al₂O₃), titanium dioxide (TiO₂), amorphous silicon (a-Si), the like, or a combination thereof, but the present disclosure is not limited thereto. As shown in FIG. 1 and FIG. 3, in this embodiment, the collimating element 40 is aligned with the well structure 31W to covert a point light ray emitted from the bio sample BS to a collimating beam.

As shown in FIG. 1 and FIG. 3, in this embodiment, the biosensing device 100 includes another upper cladding layer 33 disposed between the substrate 10 and the upper cladding layer 31. The upper cladding layer 33 may include the same or similar material to the upper cladding layer 31 and may be formed by the same or similar processes, which is described above and will not be repeated here. As shown in FIG. 1 and FIG. 3, in this embodiment, the collimating element 40 is embedded in the upper cladding layer 33 and aligned with the well structure 31W.

Moreover, in this embodiment, the biosensing device 100 further includes a waveguide layer 50 disposed between the upper cladding layer 31 and the upper cladding layer 33. In this embodiment, the collimating element 40 is embedded in the upper cladding layer 33. In some embodiments, the waveguide layer 50 includes tantalum pentoxide (Ta₂O₅), silicon nitride (Si₃N₄), niobium oxide (Nb₂O₅), aluminum oxide (Al₂O₃), the like, or a combination thereof, but the present disclosure is not limited thereto. The waveguide layer 50 may be formed by a deposition process. Examples of the deposition process is described above and will not be repeated here.

As show in FIG. 1, in some embodiments, the waveguide layer 50 has at least one grating coupler 50G. The grating coupler 50G may be formed by a photolithography process and/or an etching process. For example, the photolithography process may include photoresist coating (e.g., spin coating), soft baking, mask aligning, exposure, post-exposure baking (PEB), developing, rinsing, drying (for example, hard baking), any other suitable process, or a combination thereof, but the present disclosure is not limited thereto.

For example, a light source S1 or S2 emits light L to the grating coupler 50G of the waveguide layer 50, and a sensing light L2, which may have a wavelength of 520 nm, 532 nm, 546.1 nm, 589.3 nm, or 643.8 nm for example, is formed and passes through the waveguide layer 50. the sensing light L2 may excite bio samples BS (e.g., fluorescence molecules) to emit fluorescent light. However, the present disclosure is not limited thereto.

As shown in FIG. 1, in this embodiment, the well structure 31W is close to but does not penetrate the upper cladding layer 31. That is, there is a gap between the bottom of the well structure 31W and the waveguide layer 50. As shown in FIG. 2, in some embodiments, the distance R between the bottom of the well structure 31W and the waveguide layer 50 is in a range from about 1 nm to about 200 nm.

As shown in FIG. 3, in this embodiment, the refractive index of the bottom microlens 23 is substantially equal to the refractive index of the top microlens 21. Moreover, in this embodiment, the top microlens 21 is embedded in the upper cladding layer 33, and the refractive index of the top microlens 21 is greater than the refractive index of the upper cladding layer 33. For example, the refractive index difference between the top microlens 21 and the upper cladding layer 33 may be between about 0.01 and about 0.2, but the present disclosure is not limited thereto.

Furthermore, in this embodiment, the biosensing device 100 further includes a lower cladding layer 35 disposed under the substrate 10, and the bottom microlens 23 is embedded in the lower cladding layer 35. The lower cladding layer 35 may include the same or similar material to the upper cladding layer 31 or 33 and may be formed by the same or similar processes, which is described above and will not be repeated here. That is, the refractive index of the bottom microlens 23 is greater than the refractive index of the lower cladding layer 35. For example, the refractive index difference between the bottom microlens 23 and the lower cladding layer 35 may be between about 0.01 and about 0.2, but the present disclosure is not limited thereto.

As shown in FIG. 3, in this embodiment, the minimum distance D21 between the focus plane FP of the top microlens 21 and the top microlens 21 is equal to half the thickness T10 of the substrate 10. Similarly, the minimum distance D23 between the focus plane FP of the top microlens 21 and the bottom microlens 23 is equal to half the thickness T10 of the substrate 10. Moreover, in this embodiment, light beams LE remain collimated after passing through the bottom microlens 23, but the present disclosure is not limited thereto.

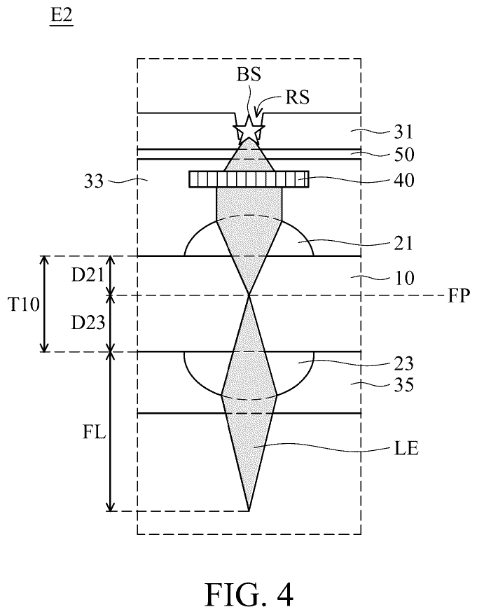

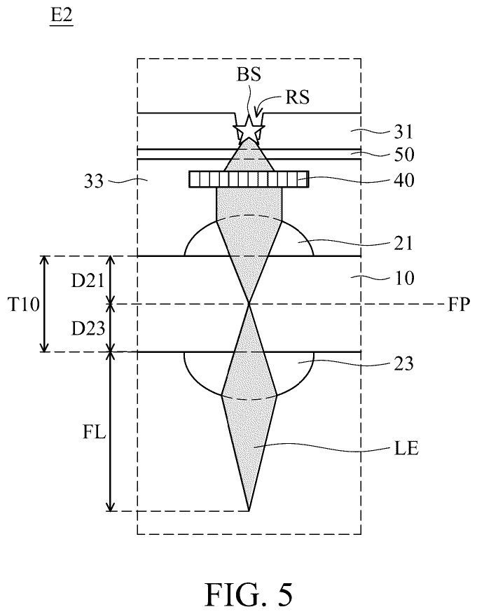

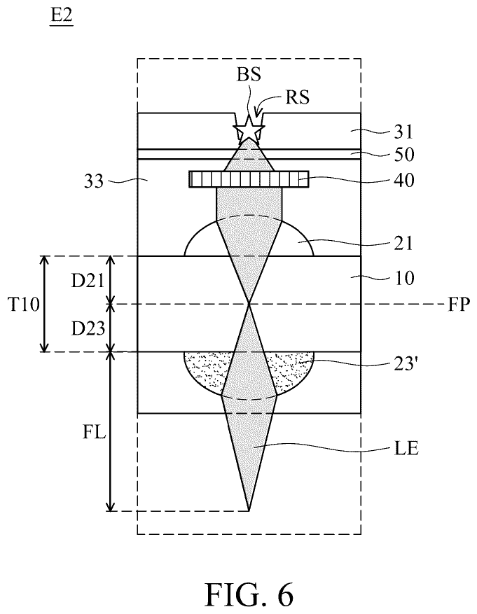

FIG. 4, FIG. 5, FIG. 6, and FIG. 7 are partially enlarged cross-sectional views illustrating the region E2 in FIG. 1 according to some other embodiments of the present disclosure. Similarly, some components of the biosensing device 100 have been omitted in FIG. 4, FIG. 5, FIG. 6, and FIG. 7 for the sake of brevity.

As shown in FIG. 4, in this embodiment, the refractive index of the bottom microlens 23 is substantially equal to the refractive index of the top microlens 21. Moreover, in this embodiment, the top microlens 21 is embedded in the upper cladding layer 33, and the bottom microlens 23 is embedded in the lower cladding layer 35. The refractive index of the top microlens 21 is greater than the refractive index of the upper cladding layer 33, and the refractive index of the bottom microlens 23 is greater than the refractive index of the lower cladding layer 35.

As shown in FIG. 4, in this embodiment, the minimum distance D21 between the focus plane FP of the top microlens 21 and the top microlens 21 is less than half the thickness T10 of the substrate 10. For example, the difference between the minimum distance D21 and half the thickness T10 is in a range from about 1 μm to about 150 μm, but the present disclosure is not limited thereto. In other words, the minimum distance D23 between the focus plane FP of the top microlens 21 and the bottom microlens 23 is longer than half the thickness T10 of the substrate 10. Moreover, in this embodiment, the focal length FL of the light beams LE after passing through the bottom microlens 23 is in a range from about 10 μm to about 5 mm or from about 50 μm to about 1 mm, but the present disclosure is not limited thereto.

As shown in FIG. 5, in this embodiment, the refractive index of the bottom microlens 23 is substantially equal to the refractive index of the top microlens 21. Moreover, in this embodiment, the top microlens 21 is embedded in the upper cladding layer 33. However, the bottom microlens 23 is not covered by any cladding layer. The refractive index of the top microlens 21 is greater than the refractive index of the upper cladding layer 33, and the refractive index of the bottom microlens 23 is greater than the refractive index of air.

As shown in FIG. 5, in this embodiment, the minimum distance D21 between the focus plane FP of the top microlens 21 and the top microlens 21 is equal to half the thickness T10 of the substrate 10. Similarly, the minimum distance D23 between the focus plane FP of the top microlens 21 and the bottom microlens 23 is equal to half the thickness T10 of the substrate 10. Moreover, in this embodiment, the focal length FL of the light beams LE after passing through the bottom microlens 23 is in a range from about 10 μm to about 5 mm or from about 50 μm to about 1 mm, but the present disclosure is not limited thereto.

As shown in FIG. 6, in this embodiment, the bottom microlens 23′ includes different material from the top microlens 21. For example, some dopants may be implanted in the bottom microlens 23', but the present disclosure is not limited thereto. Therefore, the refractive index of the bottom microlens 23′ is substantially greater than the refractive index of the top microlens 21. For example, the refractive index difference between the bottom microlens 23′ and the top microlens 21 may be between about 0.05 and about 0.5, but the present disclosure is not limited thereto.

Moreover, in this embodiment, the top microlens 21 is embedded in the upper cladding layer 33, and the bottom microlens 23′ is embedded in the lower cladding layer 35. The refractive index of the top microlens 21 is greater than the refractive index of the upper cladding layer 33, and the refractive index of the bottom microlens 23′ is greater than the refractive index of the lower cladding layer 35.

As shown in FIG. 6, in this embodiment, the minimum distance D21 between the focus plane FP of the top microlens 21 and the top microlens 21 is equal to half the thickness T10 of the substrate 10. Similarly, the minimum distance D23 between the focus plane FP of the top microlens 21 and the bottom microlens 23′ is equal to half the thickness T10 of the substrate 10. Moreover, in this embodiment, the focal length FL of the light beams LE after passing through the bottom microlens 23′ is in a range from about 10 μm to about 5 mm or from about 50 μm to about 1 mm, but the present disclosure is not limited thereto.

As shown in FIG. 7, in this embodiment, the biosensing device includes an upper planarization layer 25 disposed between the substrate 10 and the collimating element 40 and a lower planarization layer 27 disposed under the substrate 10. Moreover, in this embodiment, the top microlens 21 is embedded in the upper planarization layer 25, and the bottom microlens 23 is embedded in the lower planarization layer 27. The refractive index of the top microlens 21 is greater than the refractive index of the upper planarization layer 25, and the refractive index of the bottom microlens 23 is greater than the refractive index of the lower planarization layer 27. For example, the upper planarization layer 25 and the lower planarization layer 27 may include spin-on dopant (SOD), but the present disclosure is not limited thereto.

As shown in FIG. 7, in this embodiment, the minimum distance D21 between the focus plane FP of the top microlens 21 and the top microlens 21 is equal to half the thickness T10 of the substrate 10. Similarly, the minimum distance D23 between the focus plane FP of the top microlens 21 and the bottom microlens 23 is equal to half the thickness T10 of the substrate 10. Moreover, in this embodiment, light beams LE remain collimated after passing through the bottom microlens 23, but the present disclosure is not limited thereto.

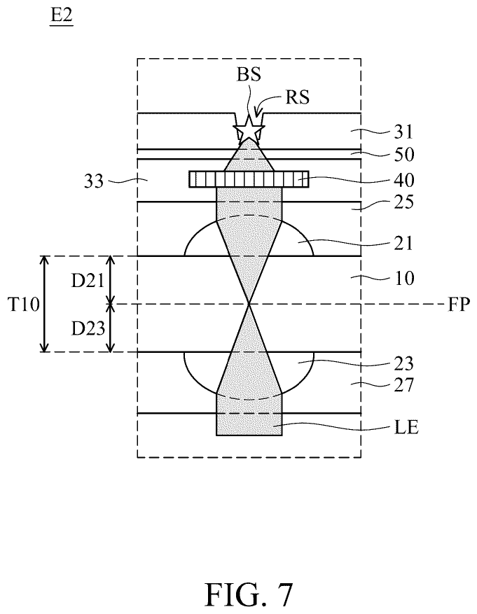

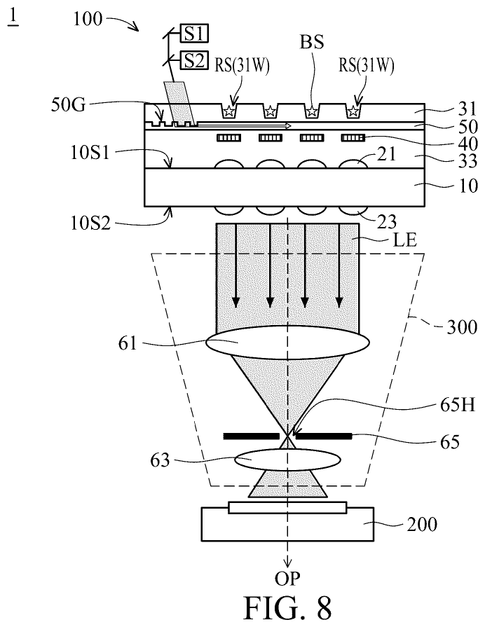

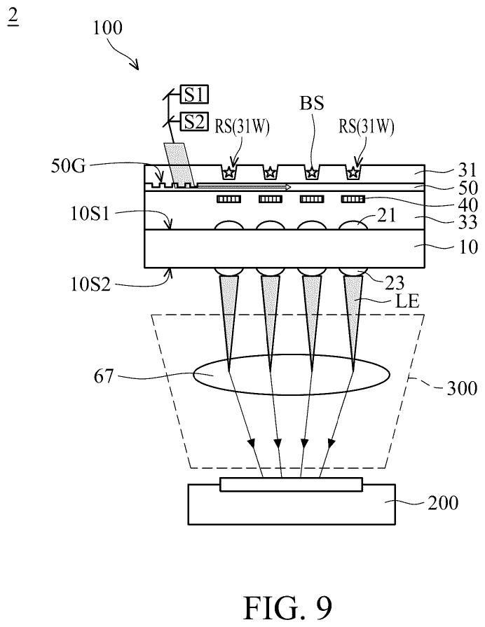

FIG. 8 is a partial cross-sectional view illustrating the optical system 1 according to some embodiments of the present disclosure. FIG. 9 is a partial cross-sectional view illustrating the optical system 2 according to some other embodiments of the present disclosure. It should be noted that some components of the optical systems 1 and 2 have been omitted in FIG. 8 and FIG. 9 for the sake of brevity.

Referring to FIG. 8, in some embodiments, the optical systems 1 includes the biosensing device 100 as shown in FIG. 1. That is, the biosensing device 100 includes a substrate 10. A top microlens 21 and a bottom microlens 23 are disposed on the two sides 10S1 and 10S2 of the substrate. The biosensing device 100 also includes an upper cladding layer 31 disposed above the substrate 10. The upper cladding layer 31 has at least one reaction site RS. The biosensing device 100 further includes a collimating element 40 disposed between the reaction site RS and the top microlens 21. The detailed structure of the biosensing device 100 may be referred to FIG. 3, FIG. 4, FIG. 5, FIG. 6, or FIG. 7, which is described above and will not be repeated here.

Moreover, as shown in FIG. 8, in some embodiments, the optical systems 1 includes an image sensor 200 for sensing light beams LE from the biosensing device 100. The optical systems 1 further includes an intermediate optical device 300 between the biosensing device 100 and the image sensor 200. For example, intermediate optical device 300 may include may include a lens or a lens assembly, and the image sensor 200 may include photodiodes, but the present disclosure is not limited thereto.

As shown in FIG. 8, in some embodiments, the intermediate optical device 300 includes an object-space lens 61 and an image-space lens 63, and the image-space lens 63 is closer to the image sensor 200 than the object-space lens 61. In this embodiment, the focal length of the object-space lens 61 is greater than or equal to the focal length of the image-space lens 63, and the focal length of the image-space lens 63 is greater than or equal to 0.1 times the focal length of the object-space lens 61 to keep the same size or shrink the image size from the light beams LE on the image sensor 200.

In some embodiments, the object-space lens 61 is a telecentric lens. Alternately, in some other embodiments, both the object-space lens 61 and the image-space lens 63 are telecentric lenses. That is, the intermediate optical device 300 forms an object-side telecentric lens or a bi-telecentric lens. As shown in FIG. 8, in some embodiments, the intermediate optical device 300 further includes a light-shielding element 65 disposed on the conjugate plane of the object-space lens 61 and the image-space lens 63. In this embodiment, the light-shielding element 65 has an aperture 65H, and the center of the aperture 65H is on the optical axis OP of the light beams LE. In the bi-telecentric optical system, the aperture 65H stop is disposed on the optical axis OP and located at the principal conjugate plane between the object-side and image-side telecentric groups (i.e., the object-space lens 61 and the image-space lens 63), such that collimated light travels symmetrically through the system.

As shown in FIG. 9, in some embodiments, the intermediate optical device 300 includes one converging lens 67 to shrink the image size from the light beams LE on the image sensor 200.

As noted above, the biosensing device and the optical system according to the embodiments of the present disclosure may achieve a high collection efficiency, a large FoV through spatially aligned optical relays, cost-effectiveness via reusable image sensor (e.g., CMOS) and disposable optical front ends, and an accurate intensity quantification over single-molecule signal arrays.

The modular design allows for seamless scaling of the number of interconnected chips, supporting diverse use cases from datacenter operations to mobile device form factors. In essence, this architecture represents a significant leap forward in the co-packaged optics domain by delivering a unified platform that merges photonic agility with silicon performance. Furthermore, the multi-chip module and the optical communications system according to the embodiments of the present disclosure may be applied for sensing (e.g., LiDAR, 3D Sensing, wearable biosensing, and so on), datacenter, all-optical computing, or cloud AI.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. A biosensing device, comprising:
a substrate;
a top microlens and a bottom microlens disposed on two sides of the substrate;
a first upper cladding layer disposed above the substrate, wherein the first upper cladding layer has at least one reaction site; and
a collimating element disposed between the reaction site and the top microlens.

2. The biosensing device as claimed in claim 1, further comprising:
a second upper cladding layer disposed between the substrate and the first upper cladding layer; and
a waveguide layer disposed between the first upper cladding layer and the second upper cladding layer.

3. The biosensing device as claimed in claim 2, wherein the waveguide layer has at least one grating coupler.

4. The biosensing device as claimed in claim 2, wherein the waveguide layer comprises tantalum pentoxide, silicon nitride, niobium oxide, or aluminum oxide.

5. The biosensing device as claimed in claim 2, wherein the reaction site is a well structure, a height of the well structure is in a range from 50 nm to 3 μm, a maximum width of the well structure is in a range from 30 nm to 5 μm, and a distance between a bottom of the well structure and the waveguide layer is in a range from 1 nm to 200 nm.

6. The biosensing device as claimed in claim 2, wherein the collimating element is embedded in the second upper cladding layer and aligned with the well structure.

7. The biosensing device as claimed in claim 2, wherein the top microlens is embedded in the second upper cladding layer, and a refractive index of the top microlens is greater than a refractive index of the second upper cladding layer.

8. The biosensing device as claimed in claim 1, wherein the collimating element comprises a metalens, a Fresnel lens, or a microlens.

9. The biosensing device as claimed in claim 1, wherein a thickness of the substrate is in a range from 50 μm to 1000 μm, and a refractive index of the substrate is in a range from 1.4 to 2.2.

10. The biosensing device as claimed in claim 9, wherein a minimum distance between a focus plane of the top microlens and the top microlens is less than or equal to half the thickness of the substrate.

11. The biosensing device as claimed in claim 1, wherein a focal length of the bottom microlens is equal to a focal length of the top microlens.

12. The biosensing device as claimed in claim 1, wherein a refractive index of the bottom microlens is greater than or equal to a refractive index of the top microlens.

13. The biosensing device as claimed in claim 1, further comprising:
a lower cladding layer disposed under the substrate, wherein the bottom microlens is embedded in the lower cladding layer.

14. The biosensing device as claimed in claim 1, further comprising:
an upper planarization layer disposed between the substrate and the collimating element, wherein the top microlens is embedded in the upper planarization layer; and
a lower planarization layer disposed under the substrate, wherein the bottom microlens is embedded in the lower planarization layer.

15. The biosensing device as claimed in claim 1, wherein light beams remain collimated after passing through the bottom microlens.

16. The biosensing device as claimed in claim 1, wherein a focal length of light beams after passing through the bottom microlens is in a range from 10 μm to 5 mm.

17. An optical system, comprising:
a biosensing device, comprising:
a substrate;
a top microlens and a bottom microlens disposed on two sides of the substrate;
a first upper cladding layer disposed above the substrate, wherein the first upper cladding layer has at least one reaction site; and
a collimating element disposed between the reaction site and the top microlens;
an image sensor for sensing light beams from the biosensing device; and
an intermediate optical device between the biosensing device and the image sensor.

18. The optical system as claimed in claim 17, wherein the intermediate optical device comprises:
an object-space lens having a first focal length;
an image-space lens having a second focal length,
wherein the image-space lens is closer to the image sensor than the object-space lens, the first focal length is greater than or equal to the second focal length, and the second focal length is greater than or equal to 0.1 times the first focal length.

19. The optical system as claimed in claim 18, wherein the object-space lens is a telecentric lens or both the object-space lens and the image-space lens are telecentric lenses.

20. The optical system as claimed in claim 18, further comprising:
a light-shielding element disposed on a conjugate plane of the object-space lens and the image-space lens,
wherein the light-shielding element has an aperture, and a center of the aperture is on an optical axis of the light beams.
